(19) United States
(12) Patent Application Publication
(10) Pub. No.: US 2012/0174584 A1
(43) Pub. Date: Jul. 12, 2012

(54) POWER PLANT SYSTEM HAVING OVERLOAD CONTROL VALVE

(76) Inventors: Martin Bennauer, Bottrop (DE); Edwin Gobrecht, Ratingen (DE); Karsten Peters, Wesel (DE)

(21) Appl. No.: 13/496,020

(22) PCT Filed: Sep. 9, 2010
(86) PCT No.: PCT/EP2010/063846

§ 371 Date: Mar. 14, 2012

(30) Foreign Application Priority Data
Sep. 22, 2009 (EP) 09012048.6

(51) Int. Cl. F01K 13/02; B23P 17/00

(52) U.S. Cl. 60/657; 29/888

(57) ABSTRACT

A power plant system and a method for operating a power plant system are provided. An overload control valve is disposed in an overload line and can be actuated by means of a pressure regulator wherein the overload control valve opens before a diverting control valve opens the valve forming a bypass between the high-pressure steam inlet and the high-pressure steam outlet as soon as a target valve is exceeded.

### CROSS REFERENCE TO RELATED APPLICATIONS

This application is the U.S. National Stage of International Application No. PCT/EP2010/063846, filed Sep. 21, 2010 and claims the benefit thereof. The International Application claims the benefits of European Patent Office application No. 09012048.6 EP filed Sep. 22, 2009. All of the applications are incorporated by reference herein in their entirety.

### FIELD OF INVENTION

The invention refers to a power plant system with a steam generator and a steam turbine according to the preamble of the claims, and also to a method for operating a power plant system according to the preamble of the claims.

### BACKGROUND OF INVENTION

Power plant systems usually comprise a steam generator and a steam turbine, which are designed in such a way that the internal energy of steam is converted into mechanical rotational energy. The generators which are driven by such steam turbines are usually operated at 50 Hz for the European market or at 60 Hz for the U.S. American market. Modern steam turbines are exposed to admission of steam which may have a pressure of up to 350 bar and a temperature of up to 700° C. This steam which is required in the steam turbine is produced in the steam generator, wherein this represents a challenge for the materials and components of the steam generator. Especially important components are the load control unit, the pressure control unit and the rotational speed control unit. In order to be able to operate the required 50 Hz or 60 Hz constantly over an extended required time period, high demands are made on the control units. Power plant systems are customarily required for base load operation which leads to the entire system being constantly stressed over an extended time period. During a continuous running operation, the frequency of the steam turbine shaft and also the volume of the steam which is fed to the steam turbine are essentially constant. It can happen, however, that in the case of a suddenly changing load in the electrical consumer network the torque transmission being applied to the generator changes, as a result of which the power output of the steam turbine could change abruptly, which is to be prevented by means of the control unit. A sudden change to the power output of the steam turbine is also made as a result of a possible malfunction.

As a rule, a power plant system is operated in constant pressure mode, variable pressure mode or on-load mode. In the specific case of the load in the consumer network being suddenly reduced, the steam turbine must transmit a lower level of torque to the generator. This could be realized by the valves which are arranged for the feed into the steam turbine being closed or by the steam generator providing a lower volume of steam at a lower pressure.

In power plant systems of today, the pressure control units are designed in such a way that a live steam pressure in a high-pressure steam system is brought to a fixed pressure value during a start-up of the steam turbine. As a rule, a bypass line is arranged in such a way that the high-pressure steam inlet of the steam turbine is fluidically connected to the high-pressure steam exit of the steam turbine.

Load rejections to station service or to no-load from the nominal power are referred to as malfunctions. In this case, both the live steam control valve and the reheat control valve close with a fast rate of travel. Since the steam generator, however, cannot reduce the output so quickly, the surplus steam has to be directed past the steam turbine. To this end, a bypass control valve, which is arranged in the bypass line, opens, as a result of which the surplus steam is directed past the steam turbine. If the pressure at full load rises above the reference value, then the overload control valve opens before the bypass control valves open. However, the surplus steam which is directed around the steam turbine is no longer used to perform work by expanding, as a result of which the efficiency of the power plant system is altogether reduced. The bypass control valve is operated in such a way that the pressure reference value of the bypass line is controlled above a variable pressure line. With a pressure increase over and above the selected margin, the bypass control valve opens and sets an upper limit on the pressure, which leads to a loss of power output.

### SUMMARY OF INVENTION

It is at this point that the invention comes in, the object of the invention being to further develop a power plant system in such a way that a power output loss is further reduced.

To this end, it is proposed, according to the invention, to provide an overload line which forms a fluidic connection between the steam generator and an overload stage of the steam turbine, and to provide an overload control valve which is arranged in the overload line and actuated via a pressure controller.

The advantage of the invention is inter alia that from now on, with pressure controlling and at full load, the surplus steam no longer has to be directed past the steam turbine via a bypass line, but is fed into the steam turbine via the overload line, albeit to an overload stage. Downstream of the overload stage, this introduced steam, expanding and performing work, is converted into rotational energy. This is to be achieved by the overload control valve opening before the bypass control valve in the bypass line opens if the pressure at full load rises above a reference value. Therefore, the overload line acts as a type of bypass station, as a result of which the steam is directed into the steam turbine instead of it being directed past the steam turbine without being utilized.

Advantageous developments are disclosed in the dependent claims. In an advantageous development, the steam turbine is constructed in such a way that the overload stage, which is fluidically connected to the overload line, is designed in such a way that the inflowing steam is converted, performing work. Therefore, an optimum use of the thermal energy of the steam is utilized in order to increase the efficiency of the power plant system as a result.

The object which is directed towards the method is achieved according to the claims. An essential feature of the method according to the invention is that the pressure controller, which actuates the overload control valve, is designed in such a way that a reference value can be set and in the event of this reference value being exceeded the bypass control valve opens only when the overload control valve is already open.

The overload control valve advantageously opens at partial load and/or at full load.

As a result of the power plant system according to the invention, or the method according to the invention for operating the power plant system, the power plant can be operated in an altogether more flexible manner since both in load control mode and in initial pressure mode the overload control valve can be actuated with any power output. A further advantage is that the starting losses and power output losses are lower since the overload control valve directs the steam into the steam turbine instead of directing it past the steam turbine into the condenser without being utilized.

### BRIEF DESCRIPTION OF THE DRAWINGS

The invention is explained in more detail based on an exemplary embodiment in the figure. In the drawing:

FIG. 1 shows a schematic layout of a power plant system,

FIG. 2 shows a graph.

### DETAILED DESCRIPTION OF INVENTION

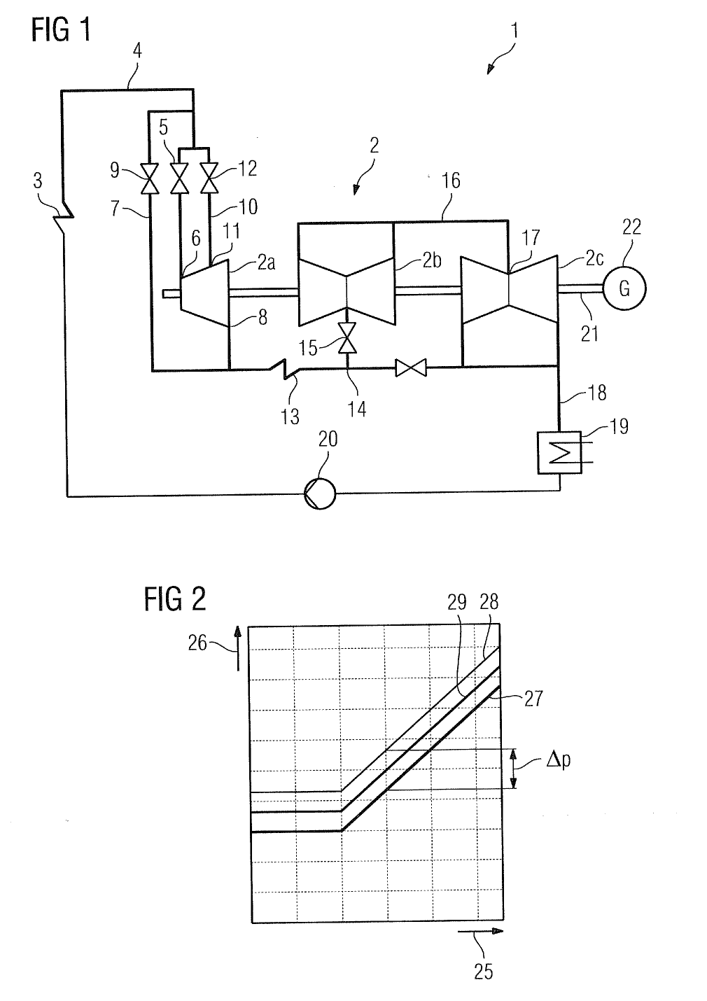

The power plant system 1 according to FIG. 1 comprises a steam turbine 2, wherein this comprises a high-pressure turbine section 2a, an intermediate-pressure turbine section 2b and a low-pressure turbine section 2c. Via a steam generator 3, live steam finds its way via a live steam line 4, via a live steam control valve 5, into a high-pressure steam inlet 6 of the high-pressure turbine section 2a. In addition to the live steam line 4, the power plant system 1 comprises a bypass line 7 which fluidically connects the live steam line 4 to a high-pressure steam exit 8 of the high-pressure turbine section 2a. A bypass control valve 9 is arranged in the bypass line 7.

Furthermore, the power plant system 1 comprises an overload line 10 which fluidically connects the steam generator 3 to an overload stage 11 of the high-pressure turbine section 2a. An overload control valve 12 is arranged in the overload line 10.

As a rule, the overload control valve 12 and the bypass control valve 9 are closed, wherein the live steam control valve 5 is open and is actuated via a pressure controller or load controller, which is not shown in more detail.

The steam which discharges from the high-pressure turbine section 2a is referred to as cold reheat steam and is heated again in a reheater 13. The steam which discharges from the reheater 13 is referred to as hot reheat steam 14. This hot reheat steam 14 flows via an intermediate-pressure control valve 15 into the intermediate-pressure turbine section 2b and is converted there, expanding and performing work. The steam which discharges from the intermediate-pressure turbine section 2b is fluidically communicated via intermediate-pressure discharge lines 16 to the low-pressure steam inlet 17 of the low-pressure turbine section 2c. The steam which discharges from the low-pressure turbine section 2c is directed via a low-pressure discharge line 18 to a condenser 19, converted into water there, and finally, via a feed-water pump 20, is directed to the steam generator 3, as a result of which a water-steam cycle is completed. The steam which is converted from the thermal energy into rotational energy drives a shaft 21 which in turn drives a generator 22 which ultimately provides electric energy.

The live steam control valve 5, the overload control valve 12 and the bypass control valve 9 are also arranged in each case on an independent separate pressure controller. The pressure controller which is responsible for the overload control valve 12 is designed in this case in such a way that a reference value can be set and in the event of this reference value being exceeded the overload control valve 12 opens before the bypass control valve 9 opens. The overload control valve 12 in this case is usually open at full load.

The steam which flows in via the overload stage 11 is converted, performing work, instead of being directed past the high-pressure turbine section 2a, via the bypass line 7, without being utilized. In so doing, the efficiency of the power plant system is further increased as a result.

For the controlling, a new pressure characteristic line for the overload control valve 12 is situated between a variable pressure characteristic line of the high-pressure turbine section 2a and the high-pressure bypass characteristic line. If the live steam pressure rises above this new pressure characteristic line, the overload control valve 12 opens but not the bypass control valve 9. The overload control valve 12 then controls a pressure which is predetermined by the new pressure characteristic line. As a result, the live steam, via the overload control valve 12, is utilized in the high-pressure turbine section 2a and not directed past the steam turbine 2 into the condenser 19 without being utilized.

Two operating cases exist in which the live steam which is generated by the steam generator cannot be fully utilized by the steam turbine. On the one hand, this happens when running up the power plant from the stationary state to nominal power or nominal rotational speed, and, on the other hand, if during nominal operation a partial or complete load shedding is carried out. In this case, the turbine generator set is adjusted to the new demands as quickly as possible, wherein the steam generator, however, can follow up only with delays. During this time, the steam continues to be produced by the boiler until the steam-pressure controller has the entire steam generation process under control again. The steam volumes which are not absorbed can be directed either into the atmosphere or the possibility exists of decoupling the steam from the steam turbine by means of fast-reacting bypass stations and allowing it to flow into the condenser. Therefore, a closed steam control circuit, from which volumes of steam are no longer lost, is maintained.

FIG. 2 shows pressure curves as a function of the steam mass flow. The live steam pressure 26 is plotted on the Y-axis and the steam generator mass flow 25 is plotted on the X-axis. The variable pressure characteristic line 27 represents the customary operating curve. If the turbine valves are completely open, the steam mass flow volumes at nominal pressure are totally absorbed by the turbine.

The reference value characteristic line 28 of the bypass station extends with a pressure difference ΔP above the variable pressure characteristic 27 line. This has the result that the bypass station is not opened too early. Not until the operating pressure is increased by the pressure difference are the bypass valves opened.

According to the invention, an additional characteristic line 29 for the overload valve control is plotted between the variable pressure characteristic line 27 and the reference value characteristic line 28. The additional characteristic line 29 lies above the variable pressure characteristic line 27 and below the reference value characteristic line 28. If the live steam pressure 26 during operation rises above that of the variable pressure characteristic line 27, then the overload control valve 12 opens first and only after that does the bypass control valve 9 open.

1-8. (canceled)

9. A power plant system with a steam generator of a steam turbine, comprising:
a live steam line for feeding live steam into the steam turbine; and
an overload line which forms a fluidic connection between the steam generator and an overload stage of the steam turbine,
wherein an overload control valve is arranged in the overload line, and
wherein provision is made for a pressure controller which is designed for actuating the overload control valve .

10. The power plant system as claimed in claim 9,
further comprising a bypass line which fluidically connects the high-pressure steam inlet to the high-pressure steam exit of the steam turbine,
wherein the bypass line comprises a bypass control valve and the pressure controller is designed in such a way that a reference value is set, and when the reference value is exceeded the bypass control valve opens only when the overload control valve is already open.

11. The power plant system as claimed in claim 9,
wherein the steam turbine comprises a high-pressure turbine section and the overload line is fluidically connected to the feed stage of the high-pressure turbine section.

12. The power plant system as claimed in claim 9, wherein the feed stage is designed in such a way that the steam turbine converts the steam which flows in via the overload line, performing work.

13. A method for operating a power plant system, comprising:
providing the power plant including a steam turbine and a live steam line for feeding live steam into the steam turbine and into an overload line;
creating a fluidic connection between a steam generator and an overload stage by means of the overload line;
arranging an overload control valve in the overload line; and
arranging a pressure controller on the overload control valve and is designed for actuating the overload control valve.

14. The method as claimed in claim 13,
wherein provision is made for a bypass line which fluidically connects the high-pressure steam inlet to the high-pressure steam exit, and
wherein provision is made for a bypass control valve, and
wherein the pressure controller is designed in such a way that a reference value is set and when reference value is exceeded the bypass control valve opens only when the overload control valve is already open.

15. The method as claimed in claim 13,
wherein the overload control valve opens at partial load and at full load.

16. The method as claimed in claim 13,
wherein the overload control valve opens at partial load or at full load.

17. The method as claimed in claim 13,
wherein the steam which flows into the steam turbine via the overload line is expanded, performing work.
